(19) United States
(12) Patent Application Publication
(10) Pub. No.: US 2007/0013883 A1
(43) Pub. Date: Jan. 18, 2007

(54) SEMICONDUCTOR MANUFACTURING DEVICE AND PARTICLE MONITORING METHOD

(76) Inventor: Il-Jung PARK, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/457,739

(22) Filed: Jul. 14, 2006

(30) Foreign Application Priority Data
Jul. 15, 2005 (KR) 2005-64413

(51) Int. Cl. G03B 27/00

(52) U.S. Cl. 355/18

(57) ABSTRACT

An embodiment of a semiconductor manufacturing device includes a chamber to perform a predetermined semiconductor process, a light source to emit light into the chamber, a light receiver to sense scattered light emitted from the light source and to measure an intensity of the scattered light, a first controller to compare the measured intensity of the scattered light with a preset reference value, and a second controller to determine whether to perform the predetermined semiconductor process based on the intensity of the scattered light. An embodiment of the particle monitoring method includes emitting laser light into a process chamber simultaneously with performing a semiconductor process, measuring an intensity of a scattered light after being emitted, comparing the measured intensity of the scattered light with a preset reference value, and interlocking the semiconductor process when the measured intensity of the scattered light is larger than the preset reference value.

### CROSS-REFERENCE TO RELATED APPLICATIONS

This application hereby claims priority under 35 U.S.C. § 119 to Korean Patent Application 2005-64413 filed on Jul. 15, 2005, of which the entire contents are hereby incorporated herein by reference.

### BACKGROUND

1. Field of the Invention

The present invention relates to a semiconductor manufacturing device, and more particularly, to a semiconductor manufacturing device and a particle monitoring method, which can detect the existence of particles in a process chamber.

2. Description of the Related Art

In the semiconductor industry, increasing the diameter of a wafer tends to reduce manufacturing costs while increasing production output. For example, wafer diameters have recently increased from 200 mm to 300 mm. Unfortunately, a downside to increasing surface areas of the semiconductor wafers is an increased likelihood of foreign particles disposed on the wafer. Because of the small features of a typical semiconductor wafer, even a very small particle can render the complete wafer defective and inoperable. Thus, there is a push in the industry for increasingly high-performance clean room environments. With this, there is a need for novel and better ways to detect these particles.

### SUMMARY

Embodiments herein provide a semiconductor manufacturing device and a particle monitoring method, which can detect the existence of particles on a wafer.

Embodiments also provide a semiconductor manufacturing device and a particle monitoring method, which can detect, by laser light, particles attached onto a wafer.

Embodiments provide semiconductor manufacturing devices including: a chamber used to perform a predetermined semiconductor process; a light source emitting light into the chamber; a light receiver sensing a scattered light emitted from the light source and measuring an intensity value of the scattered light; a first controller comparing the measured intensity of the scattered light with a preset reference value; and a second controller determining whether to perform the predetermined semiconductor process based on the intensity of the scattered light.

In some embodiments, semiconductor manufacturing devices include: a process chamber used to perform a predetermined semiconductor process; a laser light source disposed at the topside of the chamber to emit light into the process chamber in a substantially vertical direction; a light receiver disposed at one lateral side of the chamber to sense a scattered light emitted from the laser light source and to measure an intensity value of the scattered light; a first controller electrically connected to the light receiver to compare the intensity of the scattered light with a preset reference value; and a second controller electrically connected to the first controller to continuously perform the predetermined semiconductor process when the intensity of the scattered light is equal to or smaller than the present reference value and to interlock the predetermined semiconductor process when the intensity of the scattered light is larger than the preset reference value.

In further embodiments, semiconductor manufacturing devices include: a chamber used to perform a predetermined semiconductor process; a light source emitting light into the chamber; a light receiver sensing a incident light emitted from the light source and measuring an intensity of the incident light; a first controller comparing the measured intensity of the incident light with a preset reference value; and a second controller determining whether to perform the predetermined semiconductor process based on the intensity of the incident light.

In still further embodiments, semiconductor manufacturing devices include: a process chamber used to perform a predetermined semiconductor process; a laser light source disposed at one lateral side of the process chamber to emit light into the process chamber in a substantially horizontal direction; a light receiver disposed at the other lateral side of the process chamber to face the laser light source, to sense a incident light emitted from the laser light source, and to measure an intensity of the incident light; a first controller electrically connected to the light receiver to compare the intensity of the incident light with a preset reference value; and a second controller electrically connected to the first controller to continuously perform the predetermined semiconductor process when the intensity of the incident light is equal to or larger than the present reference value and to interlock the predetermined semiconductor process when the intensity of the incident light is smaller than the preset reference value.

In yet further embodiments, particle monitoring methods include: emitting laser light into a process chamber simultaneously with performing a semiconductor process; measuring an intensity of light scattered after being emitted; comparing the measured intensity of the scattered light with a preset reference value; and interlocking the semiconductor process when the measured intensity of the scattered light is larger than the preset reference value.

In still yet further embodiments, particle monitoring methods include: emitting laser light into a process chamber simultaneously with performing a semiconductor process; measuring an intensity of the laser light emitted into the process chamber; comparing the measured intensity of the laser light with a preset reference value; and interlocking the semiconductor process when the measured intensity of the laser light is smaller than the preset reference value.

The laser light source and the light receiver may be installed in the chamber of the semiconductor manufacturing device and the reflection or loss rate of the laser light may be measured to verify in real time whether or not particles exist in the chamber or on the wafer. Accordingly, the process failure can be prevented to minimize the damage or loss of the wafer. In addition, it is possible to control the process conditions and to predict the time of preventive management.

### BRIEF DESCRIPTION OF THE DRAWINGS

The accompanying drawings, which are included to provide a further understanding of the invention and are incorporated in and constitute a part of this application, illustrate embodiments of the invention and, together with the description, serve to explain the principle of the invention. In the drawings:

FIG. 1 is a cross-sectional view of a semiconductor manufacturing device according to a first embodiment;

FIG. 2 is a flowchart illustrating a particle monitoring method using the semiconductor manufacturing device according to the first embodiment;

FIG. 3 is a cross-sectional view of a semiconductor manufacturing device according to a first embodiment; and

FIG. 4 is a flowchart illustrating a particle monitoring method using the semiconductor manufacturing device according to the first embodiment.

### DETAILED DESCRIPTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention.

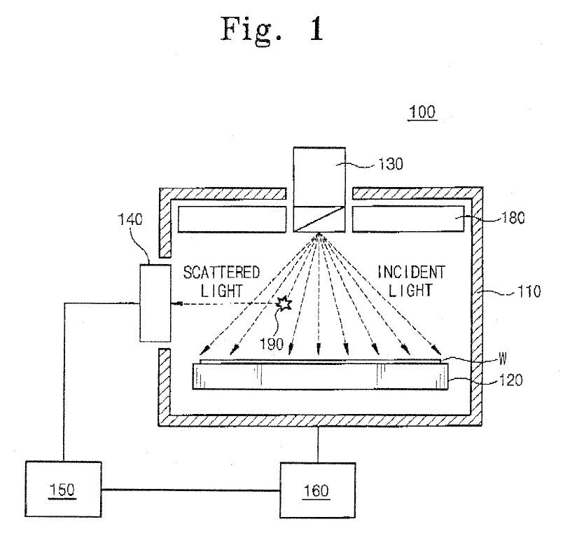

Semiconductor manufacturing devices and particle monitoring methods according to the embodiments will now be described in detail with reference to FIGS. 1 through 4.

### Embodiment 1

FIG. 1 illustrates a case where light scattered by particles in the semiconductor manufacturing device may be detected in a direction different from that of an incident light. The incident light may be laser light.

Referring to the figure, the semiconductor manufacturing device 100 includes a process chamber 110 in which a semiconductor manufacturing process may be performed. A chuck 120 may be installed at an inner bottom side of the process chamber 110 to provide a place where a wafer W is mounted. The chuck 120 may be an electrostatic chuck (ESC) that stably adheres the wafer W thereto by electrostatic force.

A light source 130 is installed at the topside of the process chamber 110. Light emitted from the light source 130 may be radiated toward the wafer W substantially vertically, as shown. A light receiver 140 may be disposed at one lateral side of the process chamber 110. In a preferred embodiment, the light receiver 140 is elevated above the surface of the wafer chuck 120. The light receiver 140 may receive light scattered by particles 190 and then may convert the received light into an electrical signal that is responsive to the intensity of the scattered light. It is preferable that the conversion into the electrical signal is linearly proportional to the intensity of the scattered light. Alternatively, the conversion may be nonlinear if the strength of the electrical signal is a one-to-one correspondence with the intensity of the scattered light. The light receiver 140 may be any photoelectric converter such as a charge-coupled device and a photomultiplier, to name a few examples.

The electrical signal converted from the scattered light may be input into a controller 150. An allowed maximum intensity of the scattered light may be preset in the controller 150. This allowed maximum intensity acts as a reference value for determining the existence and allowed density or size of particles in the process chamber 10 floating between the light source 130 and wafer W. The controller 150 may compare the strength of the input electrical signal or the measured intensity of the scattered light with the reference value. When the measured intensity of the scattered light is equal to or smaller than the reference value, the controller 150 may determine that no particle exists in the process chamber 110, or that particles exist only to the extent that they do not affect the manufacturing process. On the contrary, when the measured intensity of the scattered light is larger than the reference value, the controller 150 may determine that particles exist to the extent that they adversely affect the manufacturing process.

The controller 150 is electrically connected to a process controller 160 that controls the overall manufacturing process. When the controller 150 determines that particles exist to the extent that they may adversely affect the manufacturing process, the process controller 160 may in turn interlock the manufacturing process. Thereafter, the process controller 160 performs a subsequent process such as a cleaning process.

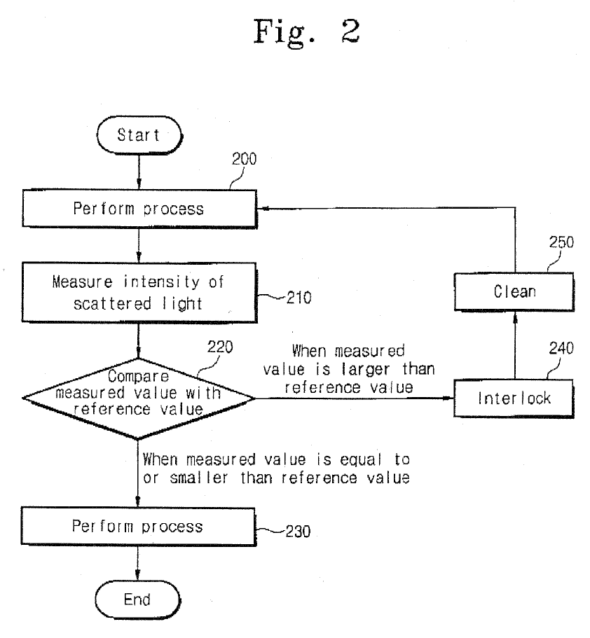

An example of an operation of the above semiconductor manufacturing device embodiment will now be described in detail with reference to FIGS. 1 and 2.

Referring to FIGS. 1 and 2, it is assumed that a wafer to be processed is loaded onto the chuck 120 and then a specific semiconductor manufacturing process, for example, a chemical vapor deposition (CVD) process, is performed in the process chamber 110.

Process gas is supplied from a shower head 180 disposed over the process chamber 110, to perform the CVD process in block 200. At this point, light, preferably laser light (e.g., continuous or pulsed) from the light source 130 is radiated toward the wafer disposed on the chuck 120 and the intensity of the scattered light is measured in block 210.

When the process chamber 10 has favorable internal conditions and few or no particles are generated therein, the incident light from the light source 130 is barely, if at all, scattered. The measured value of the scattered light is compared with a reference value in query block 220 The strength of the electrical signal transferred from the light receiver 140 to the controller 150 or the measured intensity of the scattered light may be equal to or smaller than the reference value. In this case, the process controller 160 does not interlock the ongoing CVD process and the process therefore continues in block 230 until completion or until subsequent particle detection processes determine an adverse result.

On the contrary, when particles 190 are generated considerably in the process chamber 110, light scattered by the particles 190 is sensed by the light receiver 140. The light receiver 140 converts the sensed light into an electrical signal. The controller 150 compares the strength of the electrical signal or the measured intensity of the scattered light with the reference value in query block 220 to determine whether the measured intensity of the scattered light is smaller than the reference value. When the measured intensity of the scattered light is larger than the reference value, the process controller 160 interlocks the ongoing CVD process in block 240. Thereafter, the wafer where particles are generated is unloaded from the process chamber 110 and then discarded or cleaned in block 250. If necessary, cleaning gas is injected into the process chamber 110 to clean the inside of the process chamber 110 and remove the particles 190. Thereafter, the semiconductor manufacturing process is resumed in block 200.

### Embodiment 2

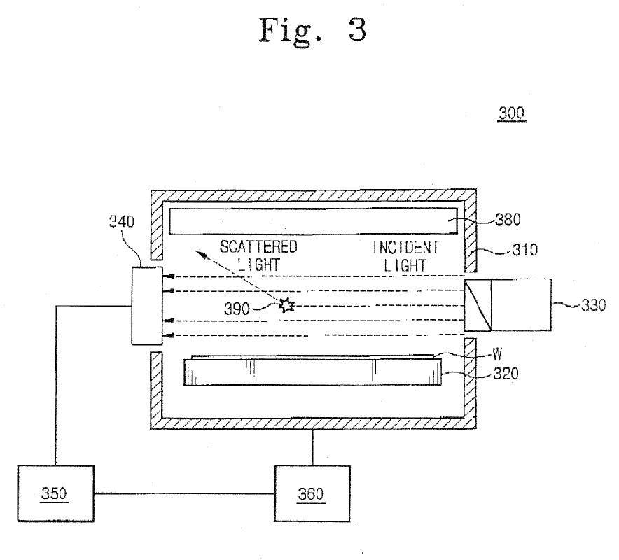

FIG. 3 illustrates a case where light scattered by particles in the semiconductor manufacturing device is monitored in a direction substantially identical to that of the incident light. Descriptions about the same contents as in FIG. 1 will be brief or omitted for conciseness, and only the differences from FIG. 1 will be described in detail.

Referring to FIG. 3, a semiconductor manufacturing device 300 includes a process chamber 310 in which a chuck 320 for mounting a wafer is installed. A light source 330, which may emit laser light, may be installed at one lateral side of the process chamber 310, and a light receiver 340 facing the light source 330 may be installed at the other lateral side of the process chamber 310.

Light emitted from the light source 330 may be radiated toward the wafer in a substantially horizontal direction. The light receiver 340 may be configured to include a photoelectric converter. The light receiver 340 may receive and convert incident light into an electrical signal. When light scattering is generated by particles 390, a portion of the incident light is lost to the scattering. In this case, the electrical signal converted from the incident light has a smaller intensity than when no particle exists.

The electrical signal converted from the incident light may be input into a controller 350. An allowed minimum intensity value of the incident light may be preset in the controller 350. This allowed minimum intensity value acts as a reference value for determining the existence of particles in the process chamber 310. The controller 350 may compare the strength of the input electrical signal or the measured intensity of the incident light with the reference value to determine whether the measured intensity of the incident light is smaller than the reference value. When the measured intensity of the incident light is equal to or larger than the reference value, the controller 350 may determine that no particle exists in the process chamber 310, or that particles exist only to the extent that they do not affect the manufacturing process. On the contrary, when the measured intensity of the incident light is smaller than the reference value, the controller 350 may determine that the particles exist to the extent that they adversely affect the manufacturing process.

The controller 350 may be electrically connected to a process controller 360 that controls the overall manufacturing process. When the controller 350 determines that particles exist to the extent that they adversely affect the manufacturing process, the process controller 360 may interlock the manufacturing process. Thereafter, the process controller 360 may perform a subsequent process such as a cleaning process.

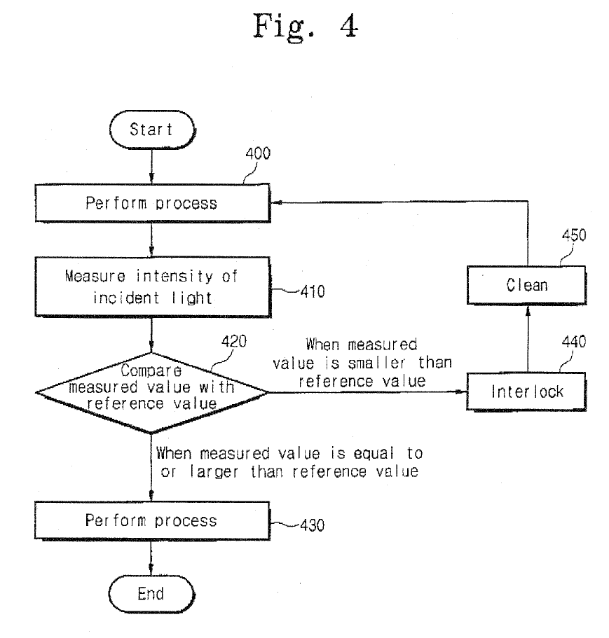

An example of an operation of the above semiconductor manufacturing device embodiment will now be described in detail with reference to FIGS. 3 and 4.

Referring to these figures, it is assumed that a wafer to be processed is loaded onto the chuck 320 and then a specific semiconductor manufacturing process (e.g., a CVD process) is performed in the process chamber 310 in block 400. Process gas is supplied from a shower head 380 disposed over the process chamber 310, to perform the CVD process. At this point, light, preferably laser light (e.g., continuous or pulsed) is emitted from the light source 330 toward the light receiver 340 in the substantially horizontal direction and the intensity of light received at detector 340 is measured in block 410.

A comparison step occurs within controller 350 of the intensity measured in block 410 with the reference value in query block 420. When the process chamber 310 has good internal conditions and few or no particles are generated therein, the incident light from the laser light source 330 is only slightly, if at all, scattered, and thus the strength of the electrical signal (or intensity of the incident light) transferred from the light receiver 340 to the controller 350 is equal to or larger than the reference value. In this case, the process controller 360 does not interlock the ongoing CVD process and the process continues in block 430.

On the contrary, when particles 390 are generated in the process chamber 310, a portion of the incident light is scattered by the particles 390. The light receiver 340 senses and converts the incident light into an electrical signal in block 410. The controller 350 compares the strength of the electrical signal or the measured intensity of the incident light with the reference value in query block 420 to determine whether the measured intensity of the incident light is smaller than the reference value. When the measured intensity of the incident light is smaller than the reference value, the process controller 360 interlocks the ongoing CVD process in block 440. Thereafter, the wafer where the particles are generated is unloaded from the process chamber 310 and then discarded or cleaned in block 450. If necessary, cleaning gas is injected into the process chamber 310 to clean the inside of the process chamber 310 and remove the particles 390. Thereafter, the semiconductor manufacturing process is resumed.

As described above, the light source and the light receiver may be installed in the chamber of the semiconductor manufacturing device and the reflection or loss rate of the light may be measured to verify in real time whether particles exist on the wafer. Accordingly, a process failure can be prevented to minimize the damage or loss of the wafer. In addition, it is possible to control the process conditions and to predict the time of preventive management.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A semiconductor manufacturing device comprising:
a chamber adapted to perform a predetermined semiconductor process;
a light source adapted to emit light into the chamber;
a light receiver adapted to measure an intensity of light incident upon the light receiver;
a first controller adapted to compare the measured intensity of the light incident upon the light receiver with a preset reference value; and
a second controller operable to determine whether to perform the predetermined semiconductor process based on an output from the first controller.

2. The semiconductor manufacturing device of claim 1, wherein the light incident upon the light receiver is scattered light produced from an interaction between the emitted light and a particle within the chamber, the light receiver adapted to measure an intensity value of the scattered light.

3. The semiconductor manufacturing device of claim 2, wherein the second controller interlocks the predetermined semiconductor process when the measured intensity of the scattered light is larger than the preset reference value.

4. The semiconductor manufacturing device of claim 2, wherein the light source is disposed at a topside of the chamber to emit light into the chamber in a substantially vertical direction.

5. The semiconductor manufacturing device of claim 4, wherein the light receiver is disposed at one lateral side of the chamber.

6. The semiconductor manufacturing device of claim 2, wherein the light receiver includes a photoelectric converter converting the scattered light into an electrical signal.

7. The semiconductor manufacturing device of claim 1, wherein the light is laser light.

8. The semiconductor manufacturing device of claim 1, wherein the light incident on the light receiver is light directly incident from the light source and does not include scattered light not incident on the light receiver produced from an interaction between the emitted light and a particle within the chamber, the light receiver adapted to measure an intensity value of the incident light.

9. The semiconductor manufacturing device of claim 8, wherein the light source is disposed at one lateral side of the chamber to emit light into the chamber in a substantially horizontal direction.

10. The semiconductor manufacturing device of claim 9, wherein the light is laser light.

11. The semiconductor manufacturing device of claim 9, wherein the light receiver is disposed at the other lateral side of the chamber to face the light source.

12. The semiconductor manufacturing device of claim 11, wherein the light receiver includes a photoelectric converter converting the incident light into an electrical signal.

13. The semiconductor manufacturing device of claim 8, wherein the second controller interlocks the predetermined semiconductor process when the measured intensity of the incident light is smaller than the preset reference value.

14. A semiconductor manufacturing device comprising:
a process chamber to perform a predetermined semiconductor process;
a laser light source disposed at the topside of the chamber to emit light into the process chamber in a substantially vertical direction;
a light receiver disposed at one lateral side of the chamber to sense scattered light of the laser light source and to measure an intensity value of the scattered light;
a first controller electrically connected to the light receiver to compare the intensity of the scattered light with a preset reference value; and
a second controller electrically connected to the first controller to continuously perform the predetermined semiconductor process when the intensity of the scattered light is equal to or smaller than the present reference value and to interlock the predetermined semiconductor process when the intensity of the scattered light is larger than the preset reference value.

15. A semiconductor manufacturing device comprising:
a process chamber to perform a predetermined semiconductor process;
a laser light source disposed at one lateral side of the process chamber to emit light into the process chamber in a substantially horizontal direction;
a light receiver disposed at the other lateral side of the process chamber to face the laser light source, to sense a incident light emitted from the laser light source, and to measure an intensity of the incident light;
a first controller electrically connected to the light receiver to compare the intensity of the incident light with a preset reference value; and
a second controller electrically connected to the first controller to continuously perform the predetermined semiconductor process when the intensity of the incident light is equal to or larger than the present reference value and to interlock the predetermined semiconductor process when the intensity of the incident light is smaller than the preset reference value.

16. A particle monitoring method comprising:
emitting laser light into a process chamber simultaneously with performing a semiconductor process;
measuring an intensity of detected light within the process chamber after being emitted;
comparing the measured intensity of the detected light with a preset reference value; and
interlocking the semiconductor process when the measured intensity of the detected light differs from the preset reference value.

17. The particle monitoring method of claim 16, wherein the step of measuring the intensity of detected light includes measuring an intensity of scattered light and the step of interlocking the semiconductor process includes interlocking the semiconductor process when the measured intensity of the scattered light is larger than the preset reference value.

18. The particle monitoring method of claim 17, further comprising continuing to perform the semiconductor process when the measured intensity of the scattered light is equal to or smaller than the preset reference value.

19. The particle monitoring method of claim 17, wherein the laser light is emitted into the process chamber in a substantially vertical direction.

20. The particle monitoring method of claim 16 wherein the step of measuring the intensity of detected light includes measuring an intensity of the laser light directly incident on a detector and the step of interlocking the semiconductor process includes interlocking the semiconductor process when the measured intensity of the detected light is smaller than the preset reference value.

21. The particle monitoring method of claim 20, further comprising continuing to perform the semiconductor process when the measured intensity of the laser light is equal to or larger than the preset reference value.

22. The particle monitoring method of claim 20, wherein the laser light is emitted into the process chamber in a substantially horizontal direction.
